(19) United States
(12) Patent Application Publication
(10) Pub. No.: US 2015/0254575 A1
(43) Pub. Date: Sep. 10, 2015

(54) LEARN-BY-EXAMPLE SYSTEMS AND METHOS

(71) Applicant: Thalchemy Corporation, Madison, WI (US)

(72) Inventors: Andrew Nere, Madison, WI (US); Mikko H. Lipasti, Lake Mills, WI (US); Atif Hashmi, Fremont, CA (US); John F. Wakerly, Glenview, IL (US)

(21) Appl. No.: 14/640,424

(22) Filed: Mar. 6, 2015

Related U.S. Application Data
(60) Provisional application No. 61/949,823, filed on Mar. 7, 2014.

(51) Int. Cl. G06N 99/00; G06N 3/08

(52) U.S. Cl. CPC G06N 99/005; G06N 3/08

(57) ABSTRACT

A learn-by-example (LBE) system comprises, among other things, a first component which provides examples of data of interest (Supply Component/Example Data component); a second component capable of selecting and configuring a classification algorithm to classify the collected data (Configuration Component), and a third component capable of using the configured classification algorithm to classify new data from the sensors (Recognition Component). Together, these components detect sensory events of interest utilizing an LBE methodology, thereby enabling continuous sensory processing without the need for specialized sensor processing expertise and specialized domain-specific algorithm development.

### CROSS-REFERENCE TO RELATED APPLICATIONS

This application claims the benefit of U.S. Provisional Patent Application No. 61/949,823, filed Mar. 7, 2014, which is hereby incorporated by reference in its entirety.

### TECHNICAL FIELD

This application relates to detection of sensory events of interest utilizing learn-by-example methodology, enabling continuous sensory processing.

### BACKGROUND

Cyber-physical systems are capable of continuous sensing of real world phenomena to enable anticipatory, context-aware, and “always-on” computing. Continuous sensing applications are becoming ubiquitous, with uses in health and safety, activity monitoring, environmental monitoring, and enhancements for user interface and experience. In many scenarios, the data from these sensors is processed and analyzed in search of particular “events of interest” (also known as “trigger signatures” or “trigger events” or “trigger signature events”).

These events of interest are quite diverse, ranging widely over different applications and sensor types. For example, a modern smartphone may use an accelerometer sensor to detect a gesture-based command. Medical and health devices may utilize continuous sensing with electrocardiogram (EKG or ECG), electroencephalography (EEG), or blood pressure sensors to monitor a patient's health and vitals. Environmental and structure monitoring devices may deploy continuous sensing applications interfaced with emission sensors, pollution sensors, or pressure sensors. Modern smartphones and tablets contain a wide array of sensors, including microphones, cameras, accelerometers, gyroscopes, and compasses. The ability to flexibly deploy continuous sensing for these and other applications has the potential to revolutionize these markets and create entirely new and unforeseen application domains.

However, in most cases, developing continuous sensing applications requires significant effort and development time. Accurately detecting events of interest often requires the developer to have expertise in sensory and signal processing. Furthermore, different algorithms, expertise, and techniques are often required across different sensor domains. For example, the algorithms and expertise needed for analyzing audio data to detect a spoken wakeup command, or “hot word”, are quite different from what's needed to analyze motion data to detect a gesture-based command. Therefore, the solution developed in one sensory domain is often not translatable to another. These traditional approaches also take a significant effort and often have extensive development times. Thus, the traditional approach for detecting events of interest is not scalable, and there is a significant need for a technology that can allow the rapid development of continuous sensing applications without requiring domain-specific expertise.

### SUMMARY

The present disclosure relates to systems and methods that enable the detection of sensory events of interest through a learn-by-example (LBE) paradigm. Specifically, a learning system is disclosed for automatically detecting events of interest by processing data collected from one or more physical sensors in a user device. The system comprises: a first component that retrieves examples of events of interest from sensor data collected from at least one physical sensor; a second component that receives the examples of events of interest from the first component, and using a processor, classifies the examples into a plurality of categories to create a configured classification algorithm capable of categorizing subsequent events of interest; and, a third component that runs the configured classification algorithm to compare newly available sensor data from the user device with the previously available examples of events of interest, and, upon the occurrence of an event of interest, determines an appropriate category of that particular event of interest detected in the newly available sensor data. The configured classification algorithm may be based on neural networking techniques. The third component of the system may generate an output signal that performs a task in the user device.

### BRIEF DESCRIPTION OF THE DRAWINGS

The above aspects and other aspects and features will become apparent to those ordinarily skilled in the art upon review of the following description of specific embodiments in conjunction with the accompanying figures, wherein:

FIG. 1 illustrates a block diagram of an LBE system and its key components, according to an embodiment of the present disclosure;

FIG. 2 illustrates a block diagram of a Supply Component/Example Data Component of an LBE system, according to an embodiment of the present disclosure;

FIG. 3 illustrates a block diagram of a Configuration Component of an LBE system, according to an embodiment of the present disclosure;

FIG. 4 illustrates a block diagram of a Recognition Component of an LBE system, according to an embodiment of the present disclosure.

FIG. 5 illustrates a flowchart showing various steps involved in an example LBE method executed by an LBE system, according to an embodiment of the present disclosure.

### DETAILED DESCRIPTION

Embodiments will now be described in detail with reference to the drawings, which are provided as illustrative examples so as to enable those skilled in the art to practice the embodiments. Notably, the figures and examples below are not meant to limit the scope to a single embodiment, but other embodiments are possible by way of interchange of some or all of the described or illustrated elements. Wherever convenient, the same reference numbers will be used throughout the drawings to refer to same or like parts. Where certain elements of these embodiments can be partially or fully implemented using known components, only those portions of such known components that are necessary for an understanding of the embodiments will be described, and detailed descriptions of other portions of such known components will be omitted so as not to obscure the description of the embodiments. In the present specification, an embodiment showing a singular component should not be considered limiting; rather, the scope is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the scope encompasses present and future known equivalents to the components referred to herein by way of illustration.

The system described herein enables the detection of a sensory event of interest by simply providing examples of the trigger events.

A typical LBE system of this disclosure comprises, among other components, the following three components:
1) Example Data Component (alternatively referred to as the “Supply Component”)—A component which supplies examples of the data that is of interest, such as an “event of interest” (also known as a “trigger signature”).
2) Configuration Component—A component capable of storing the examples of data of interest, performing distortions and manipulations on the data, selecting a classification algorithm to classify the data, and configuring that algorithm to maximize classification accuracy. In other words, this component “trains” the system based on available data of interest.
3) Recognition Component—A component capable of using the configured classification algorithm from the configuration component to detect new instances of the events of interest from one or more available sensors.

The Example Data Component could be capable of collecting data of interest from digital or analog sensors, or retrieving previously collected data, or generating data through an algorithm or some other means. Sensors may be arrayed. Sensors may be of different types, such as, microphones, accelerometers, cameras, gyroscopes, pressure sensors, flow sensors, radiation sensors, proximity sensors etc.

The Configuration Component uses a classification algorithm, such as, but not limited to, a neural network, to classify the sensor data. Sensor data may be stored, distorted, manipulated, generated, or re-arranged to aid in the configuration of the classification algorithm. The configured classification of the Configuration Component is then used by the Classification Component to classify previously stored data, new collected data, or real-time data received from sensors. The Configuration Component may be deployed as a cloud based service, a server, a desktop or laptop computer, or other computational system, or in the cyber-physical device itself.

In various system embodiments, all three components may be realized as a single device or multiple devices. For example, a single smartphone may encompass each of these components. Alternatively, each component may be deployed on a discrete, but identical version of the same smartphone. Alternatively, the Example Data Component may be deployed on a smartphone, while the Configuration Component may be deployed on a laptop computer, and the Recognition Component may be deployed on a tablet computer. Persons skilled in the art would appreciate the various possibilities of component arrangement without departing from the scope of the disclosure.

End users are increasingly using multiple devices. Even a single device may have multiple instances. In case of multiple different devices, it is possible to have multiple instances of each or some of the multiple devices. The devices may be, but are not limited to, energy-constrained devices such as smartphones, tablets, wearable health or activity monitors (such as Fitbit), medical devices, notebook computers, game consoles, smart watches, smart eye wears (such as Google Glass), integrated navigation devices, music players, entertainment portals (such as mobile TV) etc. Moreover, the LBE systems and applications are not limited to portable smart devices only. They can be extended to other platforms such as household equipment, appliances, entertainment portals (such as TVs, stereos, and videogame systems), thermostats and other home environment monitoring devices, automobiles etc.

Traditional event-of-interest detection applications require explicit sensor data analysis by the application developer. In the very simplest case, an event of interest may be detected by a threshold value. For example, detecting that an input from a pressure sensor is above a pre-defined value may indicate that a button has been pressed. However, most applications require the analysis of a time-varying signal. For example, accurate detection of a person's steps based on an accelerometer sensor requires much more than a simple threshold function, else the false-positive rate of the step detection will be quite high. False-positive rate refers to the quantified expectancy of how frequently false alarms may result. Creating systems that dependably detect complex events of interest in time-varying signals requires significant domain expertise, extensive algorithm development, and often, long application development times. Once again, it is important to note that the algorithms used for identifying different classes of trigger events like the event of a step taken or of a “hot word” spoken or of an irregularity in the heartbeat are drastically different and often the same algorithm cannot be used to recognize all of these classes of trigger events.

The technology described in this disclosure enables detection of events of interest to be learned by example (hence the name LBF), avoiding altogether the need for sensor processing expertise and algorithm development. With the technology described in this patent application, developers can create event-of-interest detecting applications with ease. Rather than developing customized algorithms for detecting new events of interest, the developer simply uses the sensor-endowed device to collect examples of the events of interest. This example data is used to train the system to detect the events of interest that it encounters in the future.

For devices that contain more than one sensor, the event of interest may require data from multiple sensing modalities. For example, modern smartphones and tablets include an array of sensors. The event of interest may require the integration of multiple sensing modalities, including but not limited to, audio, visual, acceleration, rotation, orientation (with respect to both gravity and the earth's magnetic field), pressure, and temperature. For example, an event of interest in a policeman's radio may be the simultaneous detection of the sound of a gunshot and the detection of the officer running. Upon detection of this event of interest, the radio would automatically call for reinforcements. With traditional techniques, one algorithm would need to be developed to accurately detect the sound of a gunshot using a microphone, while another algorithm would use an accelerometer sensor to detect when the officer is running. With this disclosure, the application developer would simply collect examples of accelerometer data during running, as well as audio data of a gunshot, and the system would learn an appropriate configuration to detect this event.

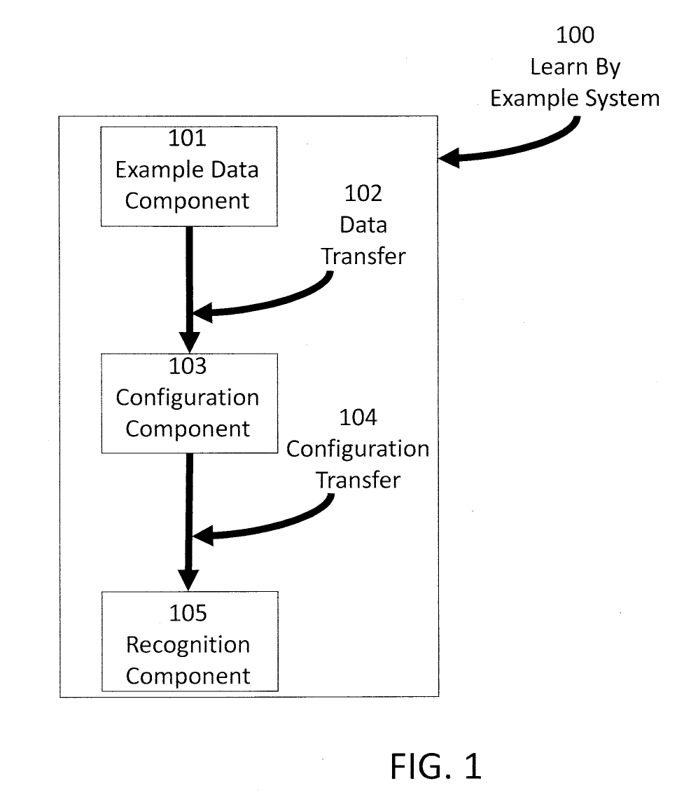

Referring to FIG. 1, a block diagram of an LBE system (100) is shown. The LBE system (100) is composed of three major components, The Example Data Component (101) provides example data of interest to the system, whether collected from one or more sensors, retrieved from previously collected data, or generated through an algorithm or other means. This data is then transferred (102) to the Configuration Component (103) via Wi-Fi, Bluetooth, USB cable, Internet, or other means. The Configuration Component (103) uses this data to configure, train, and validate a classification algorithm to accurately detect important events of interest. Once an appropriate configuration of the classification algorithm is computed, this configuration is then transferred (104) to the Recognition Component (105) of the system, using an available means including any of those mentioned for data transfer (102). The Recognition Component uses the configured classification algorithm it received to classify data, whether previously collected, newly generated, or received from sensors in real-time. The Example Data Component (101), Configuration Component (103), and Recognition Component (105) are further detailed below and in subsequent figures.

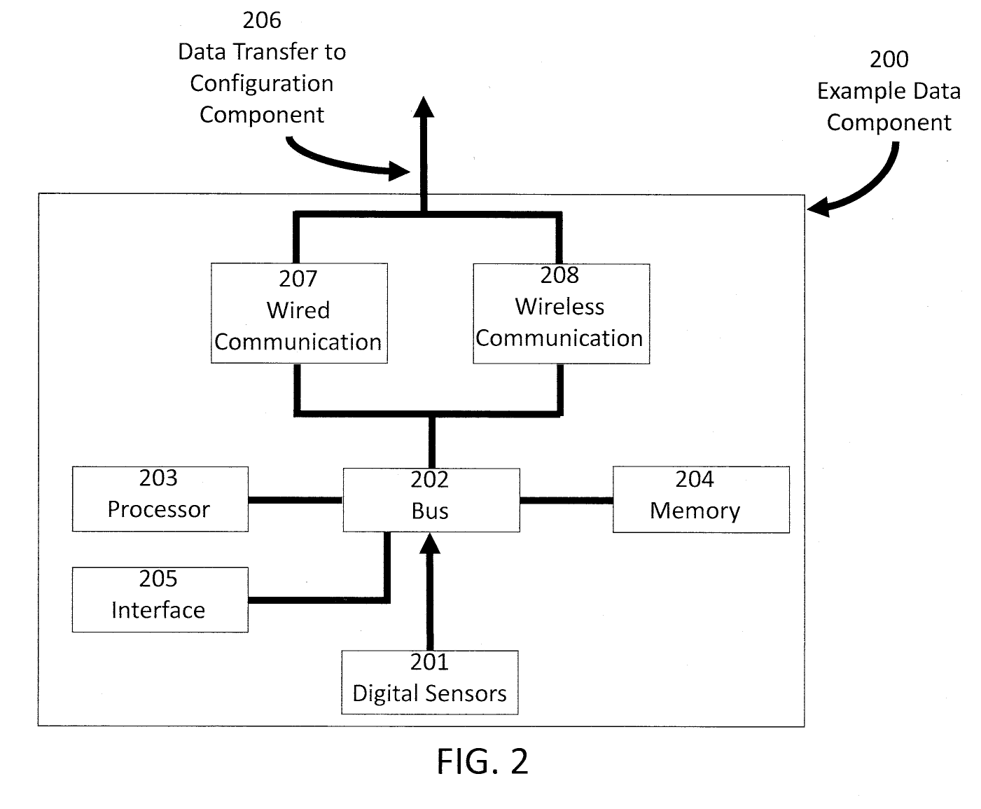

Referring to FIG. 2, a diagram of an embodiment of the Supply Component/Example Data Component (200) is presented. This is similar to and may be used as the Example Data Component (101) shown in FIG. 1. Incoming sensory data is acquired by one or more digital sensors (201), which are then communicated over a digital bus (202) to a processor (203) residing in the Example Data Component. Newly collected sensory data, previously collected data, or data generated using an algorithm may be stored in the memory (204) of the Example Data Component. Data collection or data generation are initiated with a user interface (205). In all cases, the data must be transferred to the Configuration Component of the LBE system (206). This may be through wired communication (207) (e.g. USB) or though wireless communication (208) (e.g. Wi-Fi).

In an embodiment, the Example Data Component of the system was realized as an Android application deployed on the Google LG Nexus 4 smartphone. Other operating systems and compatible devices can be used as the hardware/software platform too. This particular Android application used a single button to initiate the collection of accelerometer data. The same button was used to end the collection of accelerometer data. This Android application was used to collect complex motion based gestures, for example, drawing a five-point star in the air with the smartphone. The same application was also used to collect motion based user activity, such as walking with the phone in the user's pocket. An embodiment of the LBE system utilized the 3-axis accelerometer on the smartphone. The accelerometer can be configured to a number of different sampling rates. In one embodiment, the accelerometer was sampled at 20 Hz.

In this embodiment, the collection of the example events of interest was initiated via a user interface. However, the collection of sensor data and events of interest should not be limited to the domain of user-initiated collection. The device executing the LBE components may receive a remote command to start and stop data collection, for example, via Bluetooth or Wi-Fi.

Example events of interest can also be collected continuously or initiated automatically by the device. In this way, the device can learn to anticipate an action via sensory inputs and automatically perform the correct action. For example, an event of interest may be the detection of a user removing their smartphone from their pocket shortly before they turn the device on; in this case, the “event of interest” is the movement of the device out of the pocket, and the “action” is that the device is turned on. Automatically learning to anticipate the action requires that, for at least some period of time, a certain amount of the most recent sensor data which indicates the event of interest is continuously buffered, for example in a circular trace buffer. Upon the detection of a predefined event (such as the pressing of the ON button), the recently buffered sensor data leading up to the event would be collected as the example event of interest. The event of interest can also be collected manually by pressing a button on the trace collection app, or by other methods, such as starting and stopping trace collection remotely via a voice command, a whistle or other audio indication, or over Wi-Fi or Bluetooth. Event-of-interest samples could also be periodically collected using a timer interrupt.

To highlight the above example and capability in greater detail, one may consider the example of using an event of interest to automatically turn on a smartphone, without requiring the user to press the ON button. Initially, before any event of interest is learned, the user must still press the ON button to activate the smartphone. The sensory data of the events leading up to the button press would be captured in the circular trace buffer. For example, accelerometer and/or gyroscope data from the smartphone leading up to the button press may be captured in the circular trace buffer. After the button is pressed, data in the circular trace buffer, which indicates what happened before the button press, can be used as a trace that trains the system.

In an embodiment, recent sensor data can be buffered. Initially a new device has no recognition of any activity. However, when the algorithm recognizes that immediately before the device is turned on, it is always removed from a bag and placed on a desk, the accelerometer data can be buffered for some time. When this event takes place next time, the buffered data can be used as the trace to train the system, as the circular buffer contains a trace of the accelerometer signals relating to the removal from the bag. Over time, when the device notices this motion, the device powers on automatically.

A detection algorithm can be initiated by a user (e.g., by a button press). Alternatively, a developer may create some mechanism for automatically detecting the initiating condition that may vary from user to user. For example, for one user, taking the phone out of a pocket may be the common behavior immediately preceding the pressing of the on button. For another user, the behavior may be taking the phone out of a bag or purse. In either of these cases, a clear and identifiable event of interest can be identified using motion-detecting sensors, such as an accelerometer and/or a gyroscope. Persons skilled in the art would appreciate, in view of the current specification that collection of sensor data may be automatically initiated by an application that detects a behavioral pattern of a user before, during or after the occurrence of an event of interest.

In some embodiments, prior to the training that occurs in the Configuration Component, an additional analysis may be performed to give feedback to trace collector. For example, if the trace collector wants to use the system to recognize drawing a 5-point star in the air, the trace collector collects a number of examples (e.g. ten examples but any arbitrary number can be used) to train the system. This pre-training analysis may use similarity/difference distance metric to notify the trace collector whether the training examples collected are within a certain acceptable variance bound or if there is a significant amount of variability between the training examples collected. If there is a significant amount of variability, then the examples collected do not constitute a good training set and traces are recollected. Furthermore, highly complex events of interest may require substantially more data. The pre-training analysis can also suggest the collection of additional traces. It should be noted that this pre-training analysis is not limited to the examples described here, but can be used to provide other feedback and coaching to the user during trace collection.

A feedback loop to inform the developer about the estimated accuracy of the trained system may be built into the system. In an alternative embodiment, a feedback loop is available to the end user or other persons to train the system even if that person is not the developer. In other words, even after the developer is finished with building the program, the program can be further refined by other persons. This feedback loop may provide guidance regarding the new trigger signatures that the developer wishes to identify. This may lead the developer to consider an alternative trigger signature. For example, two gestures, such as drawing a “0” (the number zero) and “0” (the letter in the alphabet), may simply be too similar to distinguish. Once deployed on the recognition component, someone drawing a “0” may get incorrect recognitions as “0”. A feedback loop can help the developer to choose an appropriate trigger signature to reduce the chances of false positives and incorrect classifications. In the example described above, the feedback loop would tell the user during trace collection that “0” and “0” were simply too similar to ever be reliably distinguished,

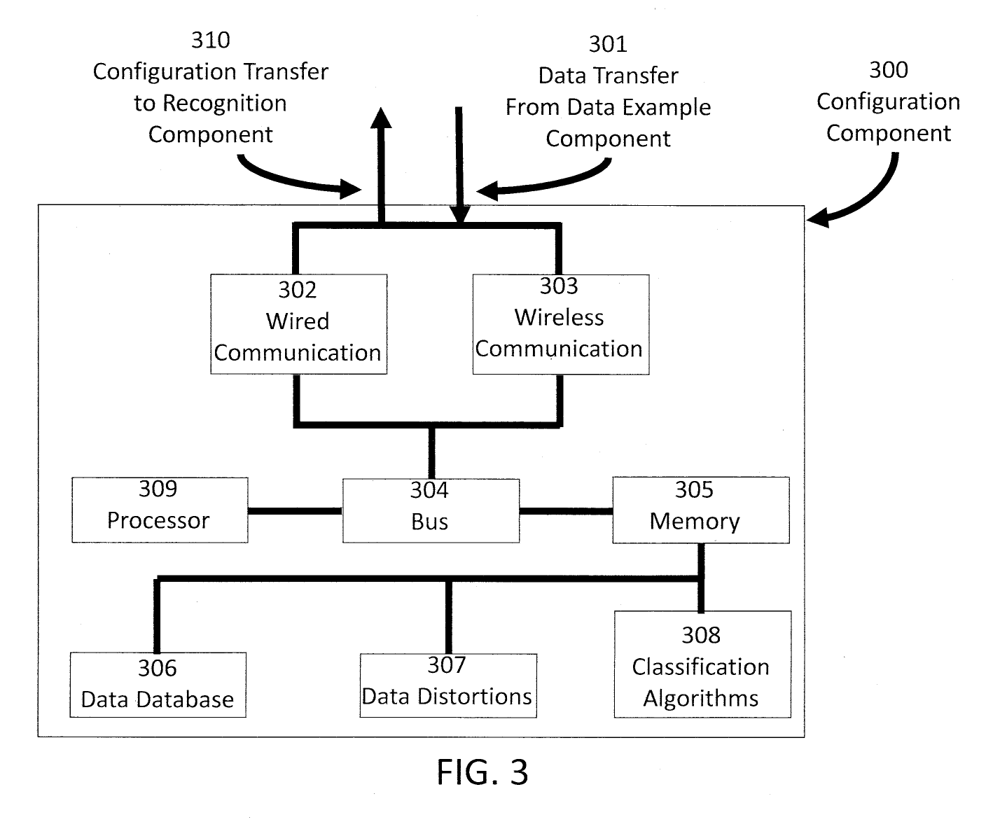

Referring to FIG. 3, a block diagram of an embodiment of the Configuration Component (300) is presented. This is similar to and may be used as the Configuration Component (103) shown in FIG. 1. Data is received from the Example Data Component (301) via wired (302) or wireless (303) communication. Received data is transferred over a bus (304) to a local memory system (305). Received data may be organized into a database of sensor data (306), and may also include a number of data manipulations, transformations, and distortions (307) which can be performed on the data. Data stored in the database of the sensor data (306) may be tagged with different descriptors relating to the sensor trace data. Examples of tags include, but are not limited to, the sampling rate of the data, the specific sensors used, the name of the user who collected the data, gender of the user, and other descriptive characteristics of the data or user. These tags can then later be used to organize and sort data for particular applications. The Configuration Component also stores one or more classification algorithms (308). The classification algorithm is executed on a processor (309), which uses the data received from the Example Data Component (301) to configure the algorithm to accurately recognize the event of interest. Once the algorithm has been appropriately trained and/or configured, the configuration is transferred (310) via wired (302) or wireless (303) communication to the Recognition Component of the system.

In an embodiment, the Configuration Component was deployed on an Intel Core 2 Duo based Personal Computer (PC). The Example Data Component, deployed on a Google LG Nexus 4 smartphone was used to collect examples of accelerometer-based events of interest. Afterwards, these events of interest were transferred to the PC using Wi-Fi. The PC, executing the Configuration Component of the system, used the collected event-of-interest examples, as well as distortions and manipulations of the data, to calculate a configuration of the classification algorithm optimized for recognition accuracy of the collected event-of-interest examples. Afterward, the configuration of the classifier was transferred back to the smartphone using Wi-Fi.

It should be noted that the software implementing the Configuration Component does not need to be deployed on a PC such as described in this example embodiment. The software component can be deployed on any computational framework. For example, the hardware that executes the Configuration Component can be the application processor of a smartphone. Similarly, the hardware could be a cloud-deployed server, a laptop PC, a hardware accelerator, or another smartphone or tablet computer.

There are several sub-components of the Configuration Component of the system. These subcomponents may include: a database (306) capable of storing collected events of interest; a component (307) capable of performing distortions and manipulations on the data, effectively expanding the number of event-of-interest “examples”; and a set of classification algorithms (308), which can be configured to accurately recognize the events of interest using the collected data and its distortions.

In an embodiment, a simple database of example event-of-interest gestures was collected from the Google LG Nexus 4 smartphone (using the Example Data Component of the embodiment). In this database, each file contained raw accelerometer data corresponding to a gesture-based event of interest. The files were labeled according to the gesture and example (Le. file “B12” corresponds to the 12^{th} example of the gesture of letter “B” drawn in the air). In one embodiment, 15 examples of each of five different complex gestures were collected for training.

It should be noted that for larger systems, a more sophisticated file system might be used for storing, organizing, searching, and using pre-collected event-of-interest traces. The file system may also be extended to include events of interest from other sensors (e.g. gyroscope, microphone, etc.) or events of interest that span multiple sensors (e.g. accelerometer and gyroscope). As described above, data may be tagged with relevant information regarding the collection device, the sensors used, and the characteristics of the user performing the data collection. These tags can later be used to organize and sort the data for particular applications. For example, one application may wish to distinguish between male and female voices, and such data tagging provides an easy way to sort the collected data.

In an embodiment, the database of events of interest could be expanded using a number of distortions and manipulations. These manipulations and distortions can be used to enhance the configuration of the classification algorithm, and test its predicted accuracy for recognizing the event of interest. In an embodiment, the following distortions and manipulations were used on the accelerometer-based gesture traces, however other distortions for other sensory modalities could also be applied:
1) Magnitude distortions—The values of the accelerometer data are multiplied by a scalar value.
2) Rotational distortions—Coordinate transformations are used to generate variations of a trace to emulate the situation where the trace is collected when the device is rotated across one or more axes.
3) Sampling rate—Sampling rates may vary depending on the device and the sensor. By manipulating the sampling rate, event-of-interest examples from one device can be appropriately sampled so the classification algorithm can be configured for deployment on another device. For example, a sampling rate of 20 Hz was typically sufficient for recognizing accelerometer-based gesture events of interest. In other examples, sampling rates of 100-200 Hz may be used depending on the device.
4) Compression and expansion—Trace is up-sampled or down-sampled to generate variations where the device used to collect the trace is moved faster or slower, thereby emulating a gesture that is performed faster or slower.

Other types of distortions and manipulations can also be used, with particular distortions and manipulations being more appropriate for particular sensor data types (i.e. audio vs. accelerometer data). These may include frequency distortions, amplitude variations, velocity distortions, coordinate translation, mirror translation, and any other methods for reshaping the data. Finally, an embodiment may also include the capability to selectively create, enable, or disable these distortions and manipulations of the data based on user discretion.

In an embodiment, a neural network algorithm was used to classify the event of interest. The neural network was composed of the traditional sigmoid-function perceptron, the most common type of artificial neural network. A perceptron is a machine-learning algorithm that is capable of linear classification of data, provided the data is organized into a vector. The perceptron contains a set of parametrizable (or trainable) “weights.” The weights are also typically organized as a vector. In typical perceptron implementation, the dot-product between the input-vector and the weight-vector are calculated, and then passed through a sigmoid function (whose purpose is to bound the outputs of the perceptron). Multiple perceptron can evaluate a single input-vector in parallel, with the “winning” perceptron being the perceptron with the highest positive output value. During training, the “weights” are adjusted to maximize the likelihood of a correct classification. This form of artificial intelligence technique is very suitable for LBE.

In an example implementation, a two-layer neural network was used. Since the accelerometer-based events of interest are a time-varying signal, the event-of-interest traces were placed in a shift register. In one implementation, the shift register was composed of 50 values (while the typical accelerometer based gesture trace included between 80 and 120 data points, considering a 20 Hz sampling rate for the accelerometer, and that most gestures are just a second or two long). This shift register was the input layer (first layer) of the neural network. The output layer (second layer) of the neural network was composed of multiple perceptron, with one perceptron per event-of-interest classification. In one implementation, five unique events of interest were used to train the classification algorithm, and thus, the network was composed of 50 input-layer neurons and 5 output-layer neurons. The 50 input-layer neurons are simply the 50 shift-register elements, while the output layer is perceptron. This is a common practice in the art of neural network algorithms—as the input layer simply reflects the input data.

The neural network was trained with the back-propagation learning algorithm, one of the most common types of neural-network training algorithms. During training, the pre-collected events of interest, as well as their manipulations and distortions, were used to train the neural network.

This neural network can be used to learn the classification of events of interest in other modalities, such as gyroscope data, or audio data. Furthermore, the neural network can also be used to classify events of interest that span multiple modalities. For example, the input layer of the neural network may comprise two shift registers of 50 elements each, one corresponding to accelerometer data, and the other corresponding to gyroscope data.

The configuration of this neural network, including the number of neurons, connectivity, weights, and bias values, may then be used by the Recognition Component of the System. Stated another way, the neural network used by the Configuration Component should normally be the same as the one that will be used by the Recognition Component of the system. In an environment where different neural networks may be used by one or more Recognition Components, the Configuration Component software may itself be configured with the parameters of the particular neural network to be used by the Recognition Component for a particular gesture, set of gestures, or event-of-interest event.

While an embodiment utilized a neural network trained with back propagation to learn the pre-collected events of interest, other algorithms can be used for this task. In the current industry approach, non-neural-network-based algorithms are often invented and developed for the task of analyzing sensory data. For example, for the task of gesture recognition, which utilizes inertial sensors such as accelerometers and gyroscopes, most implementations today utilize an understanding (and possibly a model) of the actual physical characteristics of the gesture. That is, the recognition of a particular gesture may be achieved by developing an algorithm that looks for a specific set of sequences relating to the physical characteristics of the gesture (e.g. a significant acceleration on the x-axis of the accelerometer, followed by a significant rotation around the y-axis of the gyroscope, followed by a significant rotation around the z-axis of the gyroscope indicates a particular gesture, and so on).

Similarly, in the audio sensing domain, the same kind of approach can (and is often) used for the detection of command words, For example, a frequency component lasting for a particular duration, followed by another frequency lasting for a duration, followed by another may be indicative of a particular spoken command. In both of these examples, the underlying algorithm performing the event of interest recognition considers the underlying physical characteristics of the signal (such as frequencies, or magnitudes of acceleration).

It should be noted that, while the described embodiment uses a neural network as the Recognition Component of the system, an alternative approach is to develop a more particular set of algorithms which may model an understanding of the underlying physical characteristics (such as magnitudes of acceleration, or amplitudes and durations of particular frequencies). In this alternative approach, such various parameters of the non-neural algorithms could also be modified or tuned through the learn-by-example approach.

Alternatively, other machine-learning and neural-network-based algorithms may be used for the Recognition Component of this invention, such as spiking neural networks. Support Vector Machines, k-means clustering. Bayesian networks, as well as non-machine-learning techniques. Classification algorithms may be combined and use a voting scheme to improve event-of-interest recognition accuracy and reduce the number of classified false positive identifications.

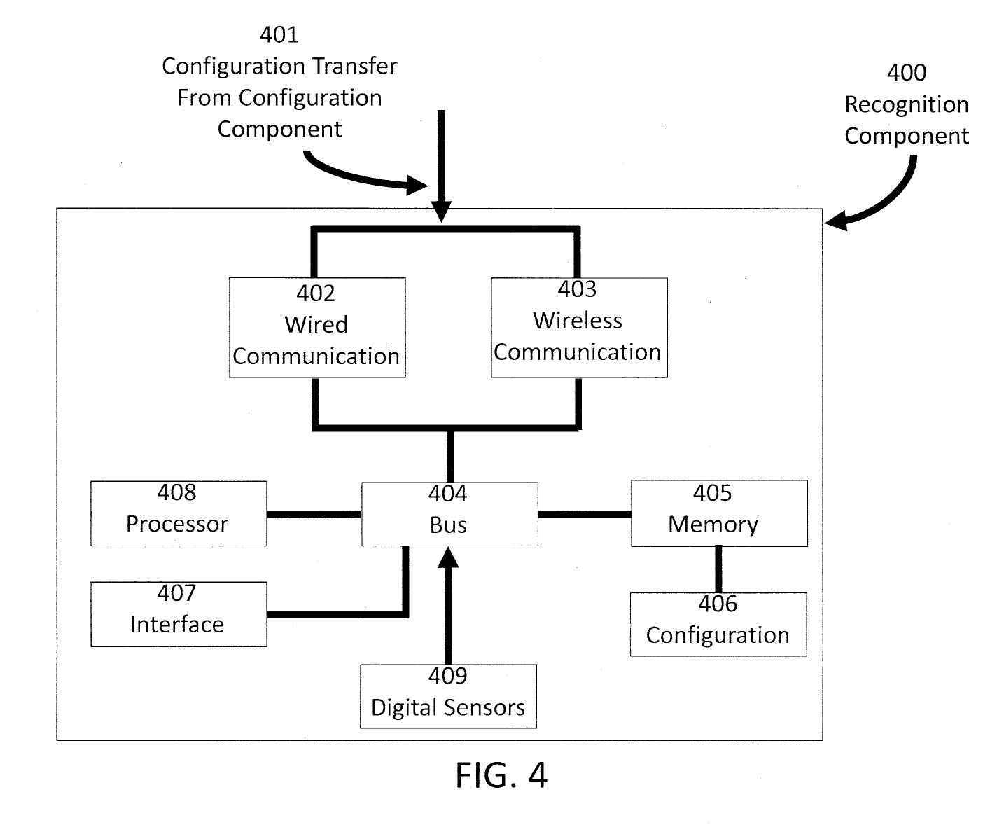

Referring to FIG. 4, a diagram of an embodiment of the Recognition Component (400) is presented. This is similar to and may be used as the Recognition Component (105) shown in FIG. 1. A configuration is received (401) from the Configuration Component of the system via wired (402) or wireless (403) communication. The received configuration is transferred over a bus (404) to a local memory system (405), which stores the configuration of the classification algorithm 406 (from the Configuration Component). The configured classification algorithm may be initiated automatically, or launched from a user interface (407), which in turn executes the classification algorithm on a traditional microprocessor (408) or another computational substrate such as a graphics processing unit (GPU), field programmable gate array (FPGA), or dedicated application-specific integrated circuit (ASIC). The executing classification algorithm then may receive new data from one or more digital sensors (409), which in turn performs real-time classification and event-of-interest recognition.

In an embodiment, the Recognition Component of the system ran on a Google LG Nexus 4 smartphone. The Recognition Component uses the optimized classifier configuration to detect new instances of the event of interest. This optimized configuration was calculated by the Configuration Component and was transferred to the smartphone using Wi-Fi. In this embodiment, the Recognition Component was deployed as an Android application running on the smartphone's main application processor.

It should be noted that the Recognition Component of the system is not limited to execution on the device's main application processor. Alternatively, the Recognition Component may be deployed as software or firmware running on a sensor hub, such as the M7 coprocessor in the Apple iPhone 5s. The Recognition Component could also be deployed on a hardware accelerator, such as a GPU, an FPGA, or a dedicated ASIC.

This software component of LBE system performs the event-of-interest detection on the device. In one embodiment, the Recognition Component was a software implementation of a neural network. This is the same neural network that was configured by the Configuration Component of the system, which specifies the number of neurons, connectivity, weights, and bias values of the neural network. This neural network ran as part of the Android application.

The Android application also sampled the accelerometer sensor at 20 Hz, and shifted these samples through a shift register. This shift register was used as the input layer (first layer) of the neural-network classification algorithm. At any time step, the perceptron in the output layer (second layer) with the greatest response gave the classification of the event of interest. To filter noise and false-positive recognitions, this response was also required to be above a minimum threshold for classification.

It should be noted that the software implementation of the event-of-interest detection algorithm is not confined to neural-network implementations. As is the case during the software learning of the event of interest, a number of machine-learning techniques and non-machine-learning-based recognition algorithms can be used for the real-time event-of-interest detection. Recognition algorithms may run on end user devices (utilizing the hardware and software installed in the device or configured to be accessed by the device) that interface with sensor data. The devices may have data collection application or other methods for collecting sensor data.

One application that can use the LBE System is gesture-based control of a smartphone. In this example, the desired application uses distinct gesture-based commands to perform different actions on the smartphone without the use of the touchscreen or buttons, such as opening an email or launching an Internet browser. The smartphone realizes both the Example Data Component and the Recognition Component of the system, while a PC executing a neural network training algorithm realizes the Configuration Component of the system.

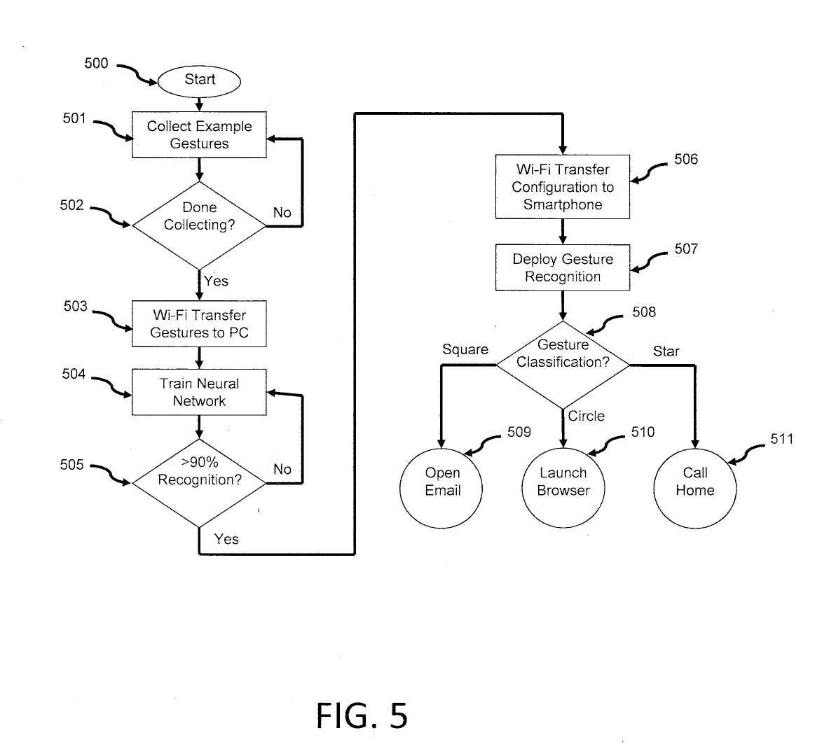

Referring to FIG. 5, an example process flow of an LBE application is illustrated. In this embodiment, the LBE application generates an output that performs a task, such as triggers the launch of one or more functions in a user device. The user decides that they wish to use three distinct gestures to perform three distinct actions, though it should be noted that the system could be scaled to recognize any number of gestures or other sensor-based actions. An application on the smartphone realizes the Example Data Component (101) of the LBE System. A button on the application is pressed to begin (500) the collection of gesture examples using a sensor, e.g. accelerometer. The user then collects examples of each of three distinct gestures: drawing a square, a circle or a star in the air with a smartphone (501), also using smartphone buttons or other means to delineate the type, start and finish of each gesture example, as will be understood by one skilled in the art. This process continues until the user has collected ten examples of each gesture (502), though, the number of required gesture examples may be different for different applications. Once the example gestures have all been collected, they are transferred to the PC over Wi-Fi (503). A neural network algorithm running on the PC is then trained to recognize the three gestures based on the examples provided by the user (504). The PC executing the neural network training algorithm realizes the Configuration Component (103) of the LBE System. Once the desired recognition accuracy is achieved, in this case, 90%, the training algorithm is stopped (505). It should be noted that other conditions could be used to determine when the training/configuration process ends, for example, after a set amount of time. Afterwards, the configuration of the neural network is transferred back to the smartphone over Wi-Fi (506). The neural network configuration (for gesture recognition) is then deployed by another application running on the smartphone (507). This is the Recognition Component (105) of the LBE System. The application then monitors the accelerometer sensor to detect whether the user has drawn one of the three command gestures as predefined by classification (508). In one example, drawing a square can be used to open email (509), a circle can be used to launch a web browser (510), and drawing a star automatically calls home (511).

Note that the task performed upon the detection of an event of interest need not be as major or significant action as opening an email, launching a web browser, or calling home. The action may be as simple as merely logging or counting that the event of interest has occurred. The intensity of the event or interest and/or a timestamp of the recognition may also be logged. Applications where such a simple action may be appropriate include step-counting, health monitoring, and environmental monitoring. The tasks also depend on which sensors are being used to collect data. Non-limiting examples of tasks performed include record a magnitude of a vibration, record the loudness detected on a microphone etc.

Furthermore, it should be noted that the output of the Recognition Component of the system need not be a “single winner”. That is, the output of the Recognition Component may indicate the recognition of multiple simultaneous events of interest, or it may include a confidence that a particular event of interest has occurred. For example, when a user is walking and performs a gesture, the Recognition Component may simultaneously indicate it has a 90% confidence that the user is walking, and an 85% confidence that the user just performed a circle gesture. The output of the Recognition Component may be customized. The output may show confidence levels for recognition, categories of recognized events of interest, or other information that the user might want to know. The output may also perform a task, such as triggering a function in the user device or in some remote device.

Persons skilled in the art would appreciate that the flowchart in FIG. 5 is an illustrative example to show how a simple LBE system would operate. The steps do not need to occur in the sequence shown. Additional steps can be added. Some of the steps may be deleted.

Using LBE scheme, the system could be configured to recognize any number of distinct gestures based on sensor data. The same scheme could be applied to user-activity monitoring, such as accurate step counting, or detecting when the user is walking, running, driving, or still. This system can also be applied to other smartphone sensor modalities, such as word recognition, or be deployed in other devices such as wearable fitness and activity monitoring devices, wearable medical devices, tablets, or notebook computers. The devices may be, but are not limited to, energy-constrained devices.

Additionally, the Recognition Component may be capable of further fine-tuning its recognition capabilities, without reference to the original set of data that was used for training. For example, the Recognition Component could similarly use a circular buffer containing the most recent sensory data, similar to the Supply Component/Example Data Component as described above. If the Recognition Component classifies a particular event of interest, the circular buffer would contain the sensory data relating to that event of interest. The neural networks weights could be slightly tuned to better recognize this event of interest, which in turn, may increase the likelihood of recognition for future occurrences. In this way, a database such as the one described above in the Configuration Component is not needed for further fine-tuning. However, one skilled in the art of neural network algorithms will understand, the value of training on the entire database of data is that it provides optimal retention for the entire dataset. Therefore, the optimal approach may be one that uses the Configuration Component database to learn the events of interest with a reasonable degree of accuracy, while the Recognition Component is capable of smaller adjustments to the algorithm, in a way that doesn't disrupt the retention of previously learned data.

In summary, this disclosure describes a system which enables configurable and customizable continuous sensory processing. The Recognition Component of this system, using a neural network algorithm, in part mimics the operation of the mammalian brain. The sensory processing solution, among other things, enables continuous detection of complex spatiotemporal signatures across multiple sensory modalities including gestures and hot words while simplifying always-on app development with a highly automated approach.

A software development kit (SDK) based on the inventive concepts herein removes the burden associated with developing always-on apps. Samples of sensory events of interest (possibly provided by software developers) may be fed into a proprietary software system that performs sophisticated signal analysis and synthesizes a customized and optimized algorithm for the sensing task at hand. The software system may be hosted in the cloud. Alternatively, the software toolkit may be deployed directly in the end-user device, or deployed on another device available to the end-user, such as a local desktop or laptop computer that communicates with the end-user device.

As discussed before, the optimized application can be deployed on devices (e.g. smartphones, tablets, etc.) that may include a sensor hub. Alternatively, for lower power and better performance, the optimized algorithm may be deployed on a custom hardware accelerator. In summary, the technology described in this disclosure is poised to enable always-on functionality, and bootstrap new application development with its LBE SDK. To bolster the system even more, a component may be included to extract and/or display attributes to the user. The sensor hub may interface with a microcontroller, an application processor and other hardware, as needed.

A database of sensor data, including templates, examples, counter examples, and noise across a large number of users and use-cases and devices is available to implement the LBE methodology. Methods for distorting the data, including frequency, sampling rate, amplitude variations, velocity distortions, coordinate translation. mirror translation, and other methods for reshaping data are used for increasing the efficacy of the LBE algorithm. Additionally, the algorithm is adaptive to selectively enable or disable to include the data distortions.

In an embodiment, automatic updates to the algorithm configuration may be available during operation. For example, if the system was trained to recognize 5-point stars, each time it recognizes a 5-point star gesture, it can slightly modify the configuration (e.g. the neural network weights) to better detect the 5-point star the next time. This continuous betterment of performance can be implemented with processes like reinforcement learning, such that the device powers on only at the optimal time. This way lower power is consumed, but the end-user does not perceive any difference in performance.

The inventive concepts have been described in terms of particular embodiments, Other embodiments are within the scope of the following claims. For example, the steps of the methods can be performed in a different order and still achieve desirable results.

The descriptions above are intended to be illustrative, not limiting. Thus, it will be apparent to one skilled in the art that modifications may be made to the embodiments as described without departing from the scope of the claims set out below.

1. A learning system for automatically detecting events of interest by processing data collected from one or more physical sensors in a user device, the system comprising:
a first component that retrieves examples of events of interest from sensor data collected from at least one physical sensor;
a second component that receives the examples of events of interest from the first component, and using a processor, classifies the examples into a plurality of categories to create a configured classification algorithm capable of categorizing subsequent events of interest; and
a third component that executes the configured classification algorithm to compare newly available sensor data from the user device with the previously available examples of events of interest, and, upon the occurrence of an event of interest, determines an appropriate category of that particular event of interest detected in the newly available sensor data.

2. The system of claim 1, wherein the third component generates an output signal that performs a task in the user device.

3. The system of claim 1, wherein the first component, the second component and the third component are physically arranged in the user device itself.

4. The system of claim 1, wherein at least one of the first, second and third components is not physically arranged in the user device, but is communicatively coupled to the user device via wired or wireless connectivity.

5. The system of claim 1, wherein the collection of sensor data is affirmatively initiated by a user by a gesture-based, tactile, or audio command, or a combination thereof.

6. The system of claim 1, wherein the collection of sensor data is automatically initiated by an application that detects a behavioral pattern of a user before, during or after the occurrence of an event of interest.

7. The system of claim 6, wherein a circular buffer in a trace collector in the first component collects traces of events of interest involving an action by a user a part of the user's behavioral pattern.

8. The system of claim 7, wherein the collected traces are used for training the system.

9. The system of claim 8, wherein a feedback loop informs a person an estimated accuracy of automatic detection of events of interest.

10. The system of claim 1, wherein the examples of events of interest are retrieved from one or more of: a remote database, a local database, and, a circular buffer of a trace collector that temporarily collects incoming sensor data to detect potential events of interest.

11. The system of claim 1, wherein the configured classification algorithm created by the second component is based on neural networking techniques.

12. The system of claim 1, wherein a software application can selectively enable or disable distortion of data used as input for the classification algorithm.

13. The system of claim 12, wherein available forms of data distortion include one or more of amplitude distortion, frequency distortion, coordinate translation, mirror translation, velocity distortion, rotational distortion, variation of sensor data sampling rate, compression, and expansion.

14. The system of claim 1, wherein the third component is configured to adjust, automatically or via user feedback, the configured classification algorithm to generate a customized output.

15. The system of claim 14, wherein the adjustment of the configured classification algorithm includes changing parameters of the configured classification algorithm to ensure better match with an example event of interest.

16. The system of claim 14, wherein the customized output includes a confidence level for recognizing one or more events of interest.

17. The system of claim 14, wherein the customized output includes identification of a plurality of events of interest detected simultaneously, wherein each event of interest is classified into a corresponding appropriate category.

18. The system of claim 17, wherein the customized output further includes respective confidence levels for recognizing each of the plurality of events of interest, or a combined confidence level.

19. A computer-implemented method for automatically detecting events of interest by processing data collected from one or more physical sensors in a user device, the method comprising:
retrieving examples of events of interest from sensor data collected from at least one physical sensor;
receiving the retrieved examples of events of interest, and using a processor, classifying the examples into a plurality of categories to create a configured classification algorithm capable of categorizing subsequent events of interest; and
executing the configured classification algorithm to compare newly available sensor data from the user device with the previously available examples of events of interest, and, upon the occurrence of an event of interest, determining an appropriate category of that particular event of interest detected in the newly available sensor data.

20. The method of claim 19, wherein the method further includes:
generating an output signal that performs a task in the user device.

21. The method of claim 19, wherein the configured classification algorithm is based on neural networking techniques.
